(19) United States
(12) Patent Application Publication
(10) Pub. No.: US 2015/0361728 A1
(43) Pub. Date: Dec. 17, 2015

(54) Cold Forming and Heat Treatment Process for Tubulars

(71) Applicant: Vetco Gray Inc., Houston, TX (US)

(72) Inventors: Jianqiang Chen, Houston, TX (US); Chad Eric Yates, Houston, TX (US)

(73) Assignee: Vetco Gray Inc., Houston, TX (US)

(21) Appl. No.: 14/740,877

(22) Filed: Jun. 16, 2015

Related U.S. Application Data
(60) Provisional application No. 62/013,313, filed on Jun. 17, 2014.

(51) Int. Cl. E21B 17/00; B21D 35/00; F16L 15/00; E21B 17/042; F16L 9/02; B21D 22/16; E21B 17/04

(52) U.S. Cl. CPC E21B 17/00; B21D 22/16; B21D 35/002; E21B 17/04; E21B 17/042; F16L 9/02; F16L 15/00; F16L 2201/40

(57) ABSTRACT

A method for forming an elongated tubular member for use with hydrocarbon production includes forming a blank member of a steel material having an outer diameter equal to a first outer diameter. The blank member is mounted on a rotating mandrel. A tubular member is formed by engaging a rotary disk with an outer surface of the blank member and moving the rotary disk in a first axial direction, lengthening the blank member in a second axial direction and reducing the outer diameter of the blank member until the outer diameter of a central portion of the blank member is equal to a second outer diameter and the outer diameter of end portions of the blank member is equal to a third outer diameter. The tubular member is heat treated to reduce a residual stress. A mechanical connection is formed in each of the end portions.

### CROSS REFERENCE TO RELATED APPLICATION

This application claims priority to and the benefit of co-pending U.S. Provisional Application Ser. No. 62/013,313 filed Jun. 17, 2014, titled “Cold Forming and Heat Treatment Process for Tubular,” the full disclosure of which is hereby incorporated herein by reference in its entirety for all purposes.

### BACKGROUND

1. Field of Disclosure

This invention relates in general to forming tubular members used in hydrocarbon drilling and production operations, and in particular to steel tubular members formed by a cold-forming process.

2. Description of Related Art

Oil and gas tubulars and tubular connections produced by some existing methods, such as welding or end upsetting, have limitations for sour services. Upsetting is a process for making a thicker sidewall at the end of a tubular member. A hot upsetting process requires heating the ends to an elevated temperature to improve the workability. Thus, the process creates a heat affected zone, which usually consists of over-tempered and untampered martensitic microstructures, in transition between heated and unheated tubular members. Hot upsetting also distorts the grain flow of the tubular material at the transition from the central region of the pipe to the thicker ends and results in distorted grain flow at the transition. Without a proper heat treatment to restore uniformity of microstructure at the transition, the tubular has inferior corrosion resistance and fatigue strength.

Welding and thermally upsetting typically creates heat affected zones (HAZ) and other anomalous structures in material, which can cause hydrogen sulfide stress-corrosion cracking, especially in tubulars where high material strength is required. Welded steel components often have poor fatigue capability in comparison with the components made of wrought steel. Referring to FIG. 1, a tubular string 10 is shown with weld 12 connecting a pipe 14 with an end connector member 16. Weld 12 can have inferior toughness and also be prone to defects such as porosities and cracks. Welding defects serve as stress risers and cause fatigue crack initiation during service. Weld thermal cycle and thermally upsetting process create a HAZ in the material of pipe 14. Weld 12 can have an inconsistent property and act as a metallurgical notch.

In addition, a HAZ can consist of multiple subzones, where each subzone has discrete microstructure. Some of the microstructures are undesirable since they have a detrimental effect on corrosion and fatigue properties. For example, the coarse grain martensitic microstructure is hard and brittle. This microstructure reduces corrosion resistance of the component. On the other hand, an over-tempered microstructure has low strength and poor fatigue capability. The HAZ thus is a weak link if it is created in oil and gas components, and can reduce the life and overall capability.

Looking at FIG. 2, tubular string 18 is shown with tubular members 20 that are formed with a hot process. During a hot forming process, the resulting tubular members 20 may not have a circular cross section and can have variations in wall thickness. The ovality of tubular members 20 requires the tubular members 20 be made oversized so that objects that are truly round, such as inner tubular goods or tools, will fit through the smaller diameter of tubular members 20. The variations in wall thickness require that tubular members 20 be made thicker than would normally be required so that the smallest thickness of tubular members 20 can handle the internal pressure within the inner bore of tubular members 20. Both of these factors result in extra material being used to form tubular members 20 than would be required from a round product with consistent wall thickness. In some current tubular members 20 that are formed with a hot process, there can be an extra 15% of material used to form tubular members 20.

Looking at FIG. 2, unless the pipe is upset before threads are cut into it, the cutting of threads will decrease the wall thickness of the tubular member 20. The wall thickness A at the full cross section will be greater than the effective wall thickness B where the threads are formed. This will create a weak point or weak region in tubular members 20. The threaded and coupled connection will often fail in tension near the first engaged thread at a lower tension than the tension at which the full cross section of the pipe with a wall thickness A would ordinarily fail.

Forming tubulars with a rolling process that is described in U.S. Pat. No. 2,336,397 can result in a tubular that does not have a uniform thickness or have precise dimensions. In a rolling process, the preform is pressed to deform by rollers. The preform does not rotate or spin in the rolling process. Rolling is a bulk deformation process which has a high strain rate and induces significant strain hardening to the preform. At a low process temperature (below recrystallization temperature), cold rolling can only produce very limited reduction in thickness to the preform, since it makes low alloy steels more brittle and reduces the ductility. Without heat treating to remove the undesirable effects of cold working, cold rolling can't efficiently reduce the thickness of low alloy steels by more than 25% (the usual ductility of low alloy steels is about 20%). Hot rolling (above recrystallization temperature) can achieve large deformation; but, it results in poor surface finish, large dimensional tolerances and inferior mechanical and metallurgical properties.

### SUMMARY OF THE DISCLOSURE

Embodiments of the current disclosure provide a weld-less, high strength tubular member. The tubular member and mechanical connection produced by the method described herein have precise dimensions and high strength. In the flow forming process, the blank member is rotated and deformed by a combination of rotation and the compressive force between rollers and mandrel. The material is displaced along an axis parallel to the rotational axis. The principal deformation takes place as one of the simple shears in plane strain. Therefore, the tubular member can be small in diameter and in wall thickness, resulting in lower weight. Flow forming is an incremental rotary point deformation process, which causes the blank member to deform in localized volume and in a small contact region. Flow forming has a much smaller strain rate and requires a much smaller force for deforming the blank member compared to a rolling process. Flow forming produces a series of small incremental deformation to the blank member, and makes the blank member incrementally deformed into the final thickness. Therefore, flow forming can achieve a much higher forming limit than cold rolling. Flow forming results in excellent surface finish, high dimensional precision, axially orientated grain structure, fine grain microstructure, and improved overall strength and fatigue strength.

Systems and methods described herein also result in a tubular member that has full strength capability compared to the current systems shown in FIGS. 1-2. Embodiments of the tubular member described herein can be formed of a low alloy steel and have ends with a greater wall thickness than a center portion of the tubular member. The tubular member can be formed by a cold-forming process and then machined to include a mechanical connection with excellent fatigue capability.

In an embodiment of this disclosure a method for forming an elongated tubular member for use with hydrocarbon production includes forming a blank member, the blank member being formed of a steel material and having an inner diameter equal to a final inner diameter and an outer diameter equal to a first outer diameter. The blank member is mounted on a rotating mandrel. A tubular member is formed by engaging a rotary disk with an outer surface of the blank member and moving the rotary disk in a first axial direction along the outer surface, lengthening the blank member in a second axial direction and reducing the outer diameter of the blank member by permanently deforming the blank member with the rotary disk, until the outer diameter of a central portion of the blank member is equal to a second outer diameter and the outer diameter of end portions of the blank member is equal to a third outer diameter, the third outer diameter being greater than the second outer diameter, and the first outer diameter being greater than both the second outer diameter and the third outer diameter, the rotating mandrel maintaining the inner diameter at the final inner diameter. The tubular member is heat treated to reduce a residual stress of the tubular member. A mechanical connection is formed in each of the end portions.

In an alternate embodiment of this disclosure, a method for forming an elongated tubular member for use with hydrocarbon drilling and production includes forming a blank member having an inner diameter equal to a final inner diameter and an outer diameter equal to a first outer diameter, the blank member having a first grain size of a metal material. The blank member is mounted on a rotating mandrel. A tubular member is cold formed by engaging a rotary disk with an outer surface of the blank member. A radial force is applied to the outer surface of the blank member, and the rotary disk is moved in a first axial direction along the outer surface, lengthening the blank member in a second axial direction and reducing the outer diameter of the blank member by permanently deforming the blank member with the rotary disk, until the outer diameter of end portions of the blank member is equal to a third outer diameter. The cold forming creates a second grain size of the metal material that is smaller than the first grain size. The tubular member is tempered to reduce a residual stress of the tubular member at a temperature below a crystallization temperature of the steel material. A mechanical connection is formed in each of the end portions.

In another alternate embodiment, a system of elongated tubular members for use with hydrocarbon drilling and production includes a tubular member formed by a method disclosed herein. The system also has an adjacent tubular member formed by a method disclosed herein, the mechanical connection of the tubular member releasably secured to the mechanical connection of the adjacent tubular member to form a tubular string.

### BRIEF DESCRIPTION OF THE DRAWINGS

So that the manner in which the features, advantages and objects of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only a preferred embodiment of the invention and is therefore not to be considered limiting of its scope as the invention may admit to other equally effective embodiments.

FIG. 1 is a section view of a prior art tubular string with a welded connection.

FIG. 2 is a section view of a prior art tubular string formed with a hot process.

FIG. 3 is a schematic perspective view of a tubular string extending between a subsea wellhead assembly and a surface platform.

FIG. 4 is a section view of a tubular string made up of cold formed tubular members formed in accordance with an embodiment of this disclosure.

FIG. 5A is a schematic view of an initial grain structure of a blank member for forming into the tubular member in accordance with an embodiment of this disclosure.

FIG. 5B is a schematic view of a final grain structure of the tubular member cold formed in accordance with an embodiment of this disclosure.

FIG. 6 is a section view of the blank member in accordance with an embodiment of this disclosure.

FIG. 7 is a section view of a tubular member being cold formed with rotary disks in accordance with an embodiment of this disclosure.

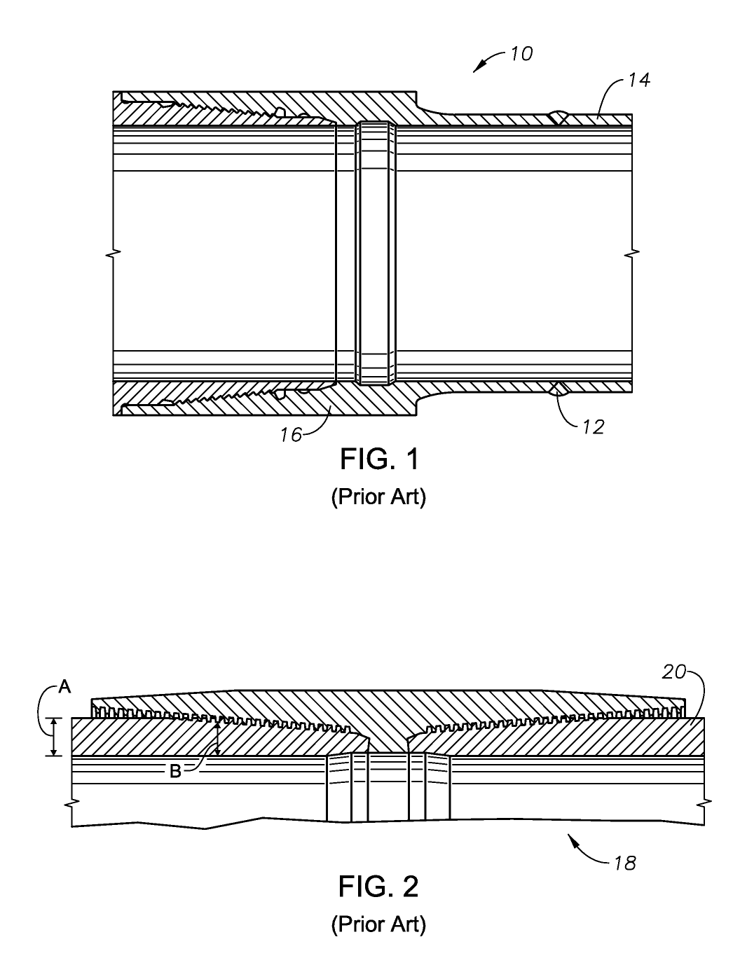

### DETAILED DESCRIPTION OF THE DISCLOSURE

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

Additionally, for the most part, details concerning rig operation, subsea assembly connections, riser use, and the like have been omitted inasmuch as such details are not considered necessary to obtain a complete understanding of the present invention, and are considered to be within the skills of persons skilled in the relevant art.

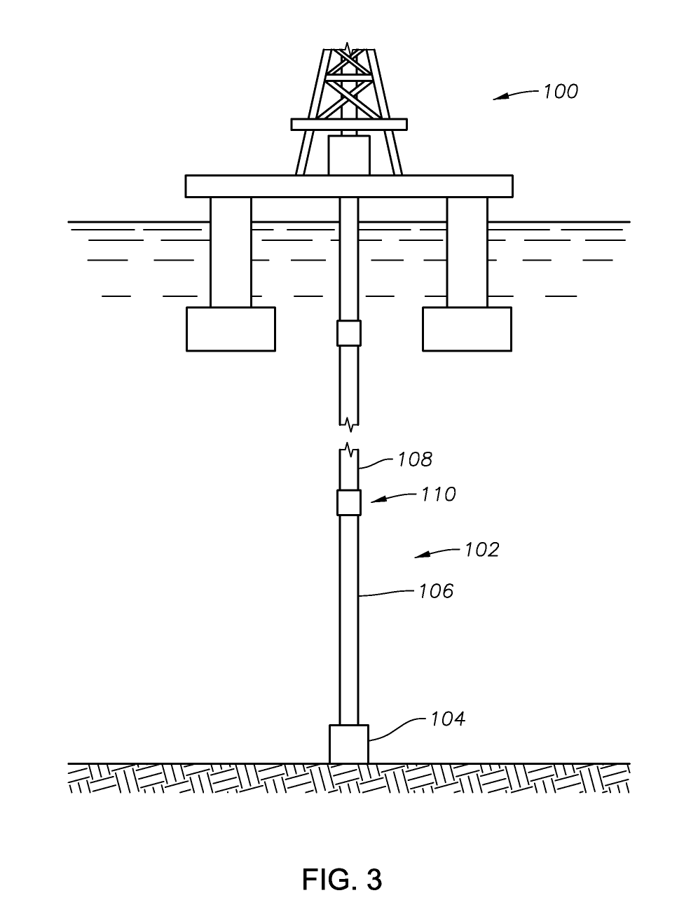

Looking at FIG. 3, one example of an offshore platform 100 having a production riser 102 extending subsea for connection with a subsea wellhead assembly 104 on the sea floor is shown. Production riser 102 can be a tubular string formed of a plurality of tubulars, for example a lower tubular member 106 and an upper tubular member 108, extending several thousand feet between platform 100 and subsea wellhead assembly 104. In the embodiment of FIG. 3, riser 13 is assembled by connecting tubular members 106, 108 at a joint 110. Because tubular members 106, 108 form such a long tubular sting and are suspended from offshore platform 100, the weight of each tubular member 106, 108 is a critical feature. FIG. 3 illustrates a single application for tubular strings used in hydrocarbon drilling or production operations. As is known by one with skill in the art, there are many alternate applications for tubular members in hydrocarbon drilling or production operations, such as casing joints, pipelines, casing hangers, flex joints and wellheads.

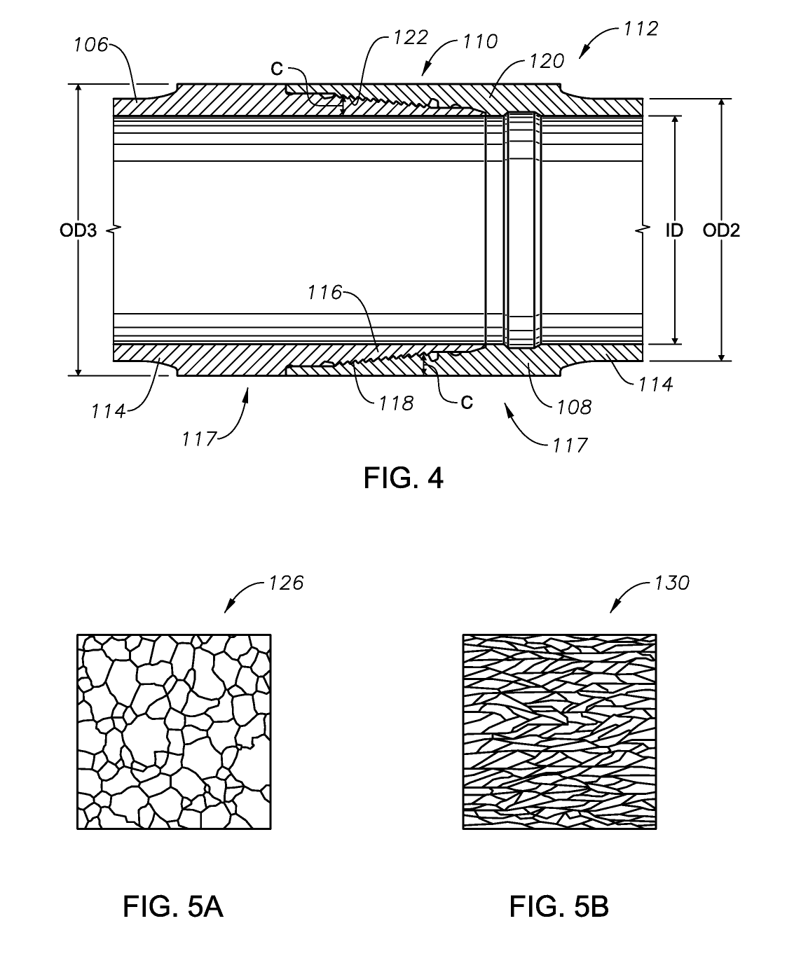

Looking at FIG. 4, tubular string 112 is shown with joint 110 in a made-up position. Lower tubular member 106 is a tubular member 114 with pin end 116. Pin end 116 has a generally conical outer diameter that is formed out of end portion 117 of tubular member 114. A mechanical connection such as outer threads or grooves 118 may be formed on an outer diameter surface of pin end 116. Upper tubular member 108 is a tubular member 114 with a box end 120 having an outer diameter substantially equivalent to the outer diameter pin end 116. Box end 120 has a general conical inner diameter that is formed out of end portion 117 of tubular member 114. A mechanical connection such as inner threads or grooves 122 can be formed on an inner diameter surface of box end 120 that mate with outer threads 118 of pin end 116.

A person skilled in the art will understand that upper tubular 108 and lower tubular 106 may be joined by any suitable means. For example, tubular members 114 may be secured by threaded couplers as shown herein, cammed couplers, collet couplers, or the like. A person skilled in the art will further understand that while the tubular members are referred to as a lower tubular member and an upper tubular member, it is not necessary that the members be assembled or positioned relative to one another as shown, but may instead be oriented in opposite or other directions relative to offshore platform 100. Tubular members 114 are formed as will be described herein.

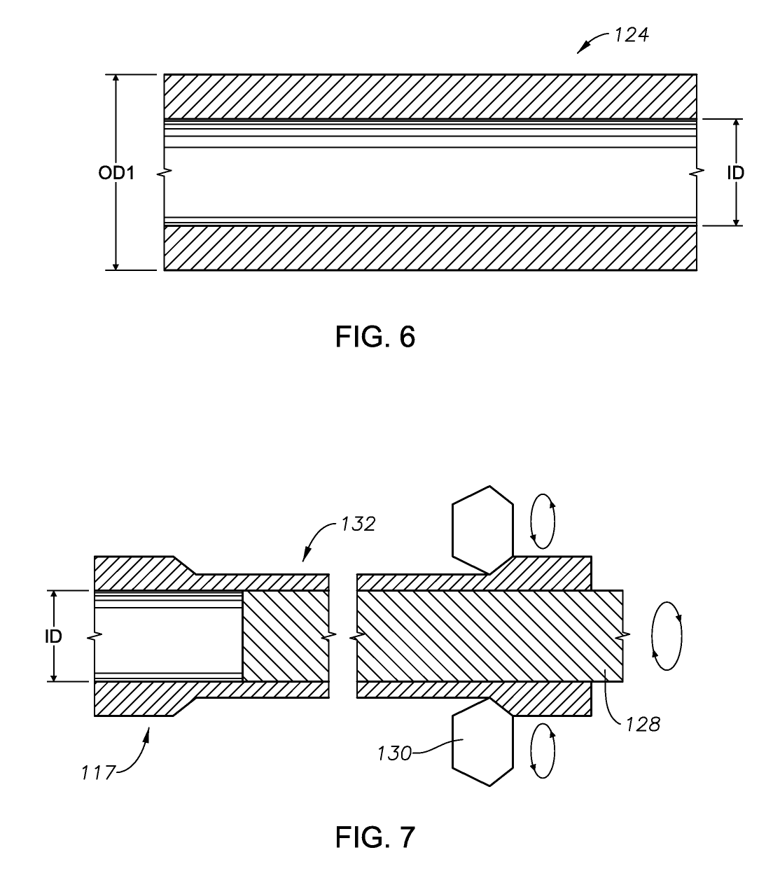

Shown in FIG. 6 is an example of blank member 124 used for forming tubular member 114. Blank member 124 can be seamless and produced by a traditional steel making process such as electrical furnace melting and casting, or extruding. Blank member 124 is formed of a steel material. As an example, blank member 124 can be formed of Cr—Mo low-alloy such as, for example, UNS G41XX0 (formerly AISI 41XX) and modifications. Blank member 124 can have grain structure 126 of FIG. 5A with an initial grain size. In an embodiment of this disclosure, blank member 124 is heat treated to have a minimum 0.2% yield strength of 100 ksi. The heat treatment can include austenitizing, quenching, a tempering processes, and combinations thereof.

Blank member 124 has inner diameter ID that is equal to or substantially similar to the final inner diameter of tubular member 114. Internal diameter ID may be machined. Blank member 124 has an outer diameter equal to a first outer diameter OD1. The length of blank member 124 as well s the first outer diameter OD1 of blank member 124 result in a total volume of material of blank member 124 that is substantially similar, or equal to, the volume of material of finished tubular member 114. In alternate examples, blank member 124 has a total volume of material that is greater than the volume of material of finished tubular member 114.

Looking at FIG. 7, an example of a cold forming process, which is a circumferentially rotated forming, and axially flowing process, in that rotary disks 130 push the material of blank member 124 primarily in a radial direction. In the example of FIG. 7, two disks 130 are shown. In alternate examples, three or more disks 130 can be used. The process of FIG. 7 is shown as a reverse flow forming process and results in a tubular member 114 that has a uniform thickness and can be formed with precise dimensions. Blank member 124 is mounted on mandrel 128. Pre-sized disks 130 engage an outer surface of blank member 124 and rotate at high speed along axes that are generally parallel with the central axis of mandrel 128. Disks 130 apply a radial force to the outer surface of blank member 124 and move in a first direction towards a mounted end of mandrel 128. Blank member 124 flows over mandrel 128 and is lengthened to extend in a second direction that is opposite the first direction towards a free end of mandrel 128. Disks 130 reduce the thickness of central portion 132 until the outer diameter of central portion 132 is equal to second outer diameter OD2. The thickness of end portions 134 is reduced until the outer diameter of each end portion 134 is equal to third outer diameter OD3. Both second outer diameter OD2 of central portion 132 and third outer diameter OD3 of end portion 134 are less than first outer diameter OD1 of blank member 124.

During the reverse flow forming process, the localized material of blank member 124 directly under disks 130 is in compression and the material of blank member 124 is permanently deformed without heating. To deform the material of blank member 124 permanently in cold work, the applied force of disks 130 damage individual crystal grains by moving existing dislocations and generating new dislocations within the lattice crystal structure. The microstructure is crushed leaving a significant residual stress and strain in the material of tubular member 114. In some embodiments, a phase change can be induced and there is a precipitation of some material constituents in the grain boundaries. During this cold forming process, the crystalline structure of blank member 124 is changed so that tubular member 114 has the elongated grain structure 131 of FIG. 5B with a final grain size. As shown, grains are elongated in a longitudinal direction. In addition, the grain size of elongated grain structure 131 is smaller than the grain size of grain structure 126 of blank member 124. Tubular member 114 will have continuous grain flow-lines that follow the contours of tubular member 114. These changes increase the strength of the material of tubular member 114 compared to the strength of the material of blank member 124. The flow forming process uses coolant to cool blank member 124 and the tooling during the flow forming process. The temperature range during the flow forming process can be between ambient temperature and 250 F. In alternate embodiments, the temperature can be up to 400 F.

Multiple cold forming passes of disks 130 over blank member 124 may be applied to reach the desired reduction ratio in wall thickness of blank member 124. In certain embodiments, the wall thickness of central portion 132 of blank member 124 can be reduced by 50% to 300% to reduce the outer diameter of blank member 124 from the first outer diameter OD1 to the second outer diameter OD2 of central portion 132 of tubular member 114. The wall thickness of end portions 117 of blank member 124 can be reduced by 0% to 75% to reduce the outer diameter of blank member 124 from the first outer diameter OD1 to the third outer diameter OD3 of end portions 117 of tubular member 114.

After tubular member 114 is cold formed, tubular member 114 may then be heat treated, such as by tempering, to obtain the desired resistance to sulfide stress-corrosion cracking for oil and gas applications. The heat treatment can relieve residual stresses and improves the ductility of the material of tubular member 114. Uniformly fine grain sizes have been shown to increase the sulfide stress cracking and the stress corrosion cracking resistance of low alloy steels. During tempering, the material of tubular member 114 is heated in a controlled manner to a temperature equal to or below the recrystallization temperature above the recovery temperature of the steel material. This causes the material to relieve residual stresses and detrimental strain working effects without changing the grain size. In one embodiment, tubular member 114 is subjected to tempering treatment at a temperature of at least about 1100 F. The material can then be cooled quickly to the ambient temperature.

The amount of cold work and post-cold-working heat treatment temperature and time may be precisely selected in order to achieve ultrafine grain microstructure of the metal material of the final tubular member 114. The ultra-fine microstructure and axially orientated grain flow-lines improve both fatigue strength and corrosion resistance of tubular member 114. This will result in a tubular member 114 with an excellent resistance to fatigue, corrosion fatigue, sulfide stress-corrosion cracking and hydrogen embrittlement. The ultrafine grain microstructure can have, for example, an average grain size equal to or finer than ASTM grain size 10. In certain embodiments, the ultrafine grain microstructure can have an ASTM grain size of greater than 13, or can have an ASTM grain size of 15.

Looking at FIG. 4, after the cold work and post-cold work heat treatment of tubular member 114, the mechanical connection such as outer threads or grooves 118 may be formed on an outer diameter surface of pin end 11 and inner threads or grooves 122 can be formed on an inner diameter surface of box end 120 that mate with outer threads 118 of pin end 116. The mechanical connection can be machined on tubular member 114. Because the third outer diameter of end portion 117 is greater than the second outer diameter of central portion 132, end portions 117 have a greater wall thickness than central portion 132 before the mechanical connections are formed on end portions 117. The mechanical connection is used to releasably attach tubular member 114 with an adjacent tubular member. As an example, one of the inner threads 122 or the outer threads 118 of tubular member 114 can engage threads of the adjacent member.

Therefore, even after the mechanical connections are formed on end portions 117, tubular member 114 when part of tubular string 112 will have the full tensile capability of the central portion 132 of tubular member 114. As an example, the mechanical connection can have an engagement point where tubular members 106, 108 are attached at a joint 110. In the case of a threaded mechanical connection, this can be where the first or innermost threads of one of the tubular members 106, 108 engage the threads of the other of the tubular member 106, 108. At the engagement point, after the mechanical connection is formed, the engagement point wall thickness C can be at least equal to the wall thickness at central portion 132 of tubular member 114.

Therefore, embodiments of this disclosure result in tubular member 114 with a high strength that is particularly useful for hydrocarbon drilling and production operations, such as for oil and gas industry applications. Tubular members 114 formed by the systems and methods described herein have high fatigue capability are light weight, and have a high resistance to hydrogen sulfide stress-corrosion cracking and is suitable for sour service. Tubular members 114 are low cost relative to tubulars formed of high alloy steels and super alloys. The systems and method described herein produce tubular members 114 with precise dimensions (concentricity, thickness, straightness) without weld joints, material defects, or anomalies. Because tubular member 114 has precise dimensions and high strength, it can be smaller in diameter compared to direct threaded and coupled pipe, or seamless pipe with upset ends. The amount of cold working and the subsequent tempering treatment are carefully designed so that extremely fine grain sizes may achieve much finer than hot worked material, and also the toughness of the material is retained, and the residual stresses are relieved.

The terms “vertical”, “horizontal”, “upward”, “downward”, “above”, and “below” and similar spatial relation terminology are used herein only for convenience because elements of the current disclosure may be installed in various relative positions.

The system and method described herein, therefore, are well adapted to carry out the objects and attain the ends and advantages mentioned, as well as others inherent therein. While a presently preferred embodiment of the system and method has been given for purposes of disclosure, numerous changes exist in the details of procedures for accomplishing the desired results. These and other similar modifications will readily suggest themselves to those skilled in the art, and are intended to be encompassed within the spirit of the system and method disclosed herein and the scope of the appended claims.

What is claimed is:

1. A method for forming an elongated tubular member for use with hydrocarbon drilling and production, the method comprising the steps of:
(a) forming a blank member, the blank member being formed of a steel material and having an inner diameter equal to a final inner diameter and an outer diameter equal to a first outer diameter;
(b) mounting the blank member on a rotating mandrel;
(c) forming a tubular member by engaging a rotary disk with an outer surface of the blank member and moving the rotary disk in a first axial direction along the outer surface, lengthening the blank member in a second axial direction and reducing the outer diameter of the blank member by permanently deforming the blank member with the rotary disk, until the outer diameter of a central portion of the blank member is equal to a second outer diameter and the outer diameter of end portions of the blank member is equal to a third outer diameter, the third outer diameter being greater than the second outer diameter, and the first outer diameter being greater than both the second outer diameter and the third outer diameter, the rotating mandrel maintaining the inner diameter at the final inner diameter;
(d) heat treating the tubular member to reduce a residual stress of the tubular member; and
(e) forming a mechanical connection in each of the end portions.

2. The method according to claim 1, wherein step (a) includes forming the tubular member with a yield strength of at least 100 ksi at a 0.2% offset strain.

3. The method according to claim 2, wherein step (a) includes heat treating the tubular member to achieve the yield strength of at least 100 ksi at a 0.2% offset strain.

4. The method according to claim 1, wherein the steel material in step (a) has an initial grain size and the steel material in step (d) has a final grain size, the final grain size being smaller than the initial grain size.

5. The method according to claim 1, wherein the mechanical connection has an engagement point for engaging an adjacent member, the engagement point having a wall thickness equal to at least a wall thickness at the central portion.

6. The method according to claim 5, wherein the mechanical connection is threads and the engagement point is a location where an innermost thread engages the mechanical connection of the adjacent member.

7. The method according to claim 1, wherein step (d) is performed at a temperature below a crystallization temperature of the steel material.

8. The method according to claim 1, wherein step (c) is performed at a temperature of no more than 400 F.

9. A method for forming an elongated tubular member for use with hydrocarbon drilling and production, the method comprising the steps of:
(a) forming a blank member having an inner diameter equal to a final inner diameter and an outer diameter equal to a first outer diameter, the blank member having a first grain size of a metal material;
(b) mounting the blank member on a rotating mandrel;
(c) cold forming a tubular member by engaging a rotary disk with an outer surface of the blank member, applying a radial force to the outer surface of the blank member, and moving the rotary disk in a first axial direction along the outer surface, lengthening the blank member in a second axial direction and reducing the outer diameter of the blank member by permanently deforming the blank member with the rotary disk, until the outer diameter of end portions of the blank member is equal to a third outer diameter, the cold forming creating a second grain size of the metal material that is smaller than the first grain size;
(d) tempering the tubular member to reduce a residual stress of the tubular member at a temperature below a crystallization temperature of the metal material; and
(e) forming a mechanical connection in each of the end portions.

10. The method according to claim 9, wherein step (e) includes forming outer threads on an outer diameter surface of a first end portion and forming inner threads on an inner diameter surface of a second end portion.

11. The method according to claim 10, further comprising releasably securing the tubular member to an adjacent member by engaging one of the inner threads or the outer threads of the tubular member with the adjacent member.

12. The method according to claim 9, wherein step (c) includes pushing the metal material of the blank member in a primarily radial direction.

13. The method according to claim 9, wherein the mechanical connection has an engagement point for engaging an adjacent member, the engagement point having a wall thickness equal to at least a wall thickness at a central portion of the tubular member.

14. The method according to claim 13, wherein the mechanical connection is threads and the engagement point is a location where an innermost thread engages the mechanical connection of the adjacent member.

15. The method according to claim 9, wherein step (a) includes forming the tubular member by heat treating the tubular member to achieve a yield strength of at least 100 ksi at a 0.2% offset strain.

16. A system of elongated tubular members for use with hydrocarbon drilling and production, the system comprising:
a tubular member formed by the method of claim 1; and
an adjacent tubular member formed by the method of claim 1, the mechanical connection of the tubular member releasably secured to the mechanical connection of the adjacent tubular member to form a tubular string.

17. The system according to claim 16, wherein the tubular string extends from an offshore platform to a subsea wellhead assembly.

18. The system according to claim 16, wherein the blank member has an initial grain size and the tubular member has a final grain size, the final grain size being smaller than the initial grain size.

19. The system according to claim 16, wherein the mechanical connection of the tubular member has an engagement point for engaging an adjacent member, the engagement point having a wall thickness equal to at least a wall thickness at the central portion.

20. The system according to claim 19, wherein the mechanical connection is threads and the engagement point is a location where an innermost thread engages the mechanical connection of the adjacent member.

21. The system according to claim 16, wherein the blank member has a yield strength of at least 100 ksi at a 0.2% offset strain.
